(19) United States
(12) Patent Application Publication
(10) Pub. No.: US 2016/0023441 A1
(43) Pub. Date: Jan. 28, 2016

(54) WINDOW LAYER FOR REFLECTING INFRARED LGIHT

(71) Applicant: YUAN ZE UNIVERSITY, Taoyuan (TW)

(72) Inventor: Tien-Lung CHIU, Taoyuan (TW)

(21) Appl. No.: 14/445,041

(22) Filed: Jul. 28, 2014

(51) Int. Cl. B32B 27/06; B32B 27/36

(52) U.S. Cl. CPC B32B 27/06; B32B 27/36; B32B 2250/03; B32B 2307/416

(57) ABSTRACT

A window layer structure for reflecting an infrared light is disclosed, where the window layer not only reflects the infrared light having a first wavelength range by its window film layer, but also reflects the infrared light having a second wavelength range by using its cholesteric liquid crystal layer, so that the window layer structure may reflect the infrared light of a large portion of wavelengths and reduce an absorption of the infrared light. Therefore, the window layer for reflecting an infrared light may provide a more efficient isolation effect.

### BACKGROUND OF RELATED ART

1. Technical Field

The present invention is related to a window layer structure, and particularly to a window layer structure for reflecting an infrared light.

2. Related Art

Due to presence of the global warming effect, the ambient temperature becomes increasingly high, particularly at the summer time. To avoid a too high indoor temperature, the masses are forced to employ air-conditioners to reduce the indoor temperature. According to the survey, almost half the total energy in some countries is spent on temperature conditioning, so as to have a comfort feeling.

In addition, some screening articles for blocking or reflecting an inward light, such as a window coating or a window layer, are used to inhibit an increase of the indoor temperature resulted from sun. In this manner, a cooling effect is achieved within buildings or transportation systems.

The current window layer comprises a polyethylene terephthalate (PET) layer, a metal reflection an organic dye coating layer, a scrape-protecting layer, and a sticker coating layer. The window layer reflects the infrared and ultraviolet lights by its metal reflection coating layer and absorbs the infrared light through its organic dye coating layer, so that a heat isolation effect may be achieved.

Referring to FIG. 1, which is a schematic diagram for a heat energy accumulation in a prior art window layer.

Since the metal reflection layer of the window layer 50 may only reflect a certain wavelength range portion of infrared light 51, the infrared light 52 of the wavelength range is absorbed by the organic dye coating layer of the window layer 50. This may result in a more rapid heat energy accumulation speed of the organic dye coating layer of the window layer 50.

When the organic dye coating layer of the window layer 50 absorbs an excess of infrared light 52, the heat energy 51 accumulated in the window layer 50 will release in a heat radiation manner since a huge of heat energy 51 is accumulated in the window layer 50. This results in an increased temperature in a space needed to be isolated with heat, increasing a largely reduced heat isolation effect of the window layer 50.

In view of the above, it may be known that there has long been an issue of a poor infrared light reflection amount and thus a largely reduced heat isolation effect when an excess of infrared light is absorbed. Therefore, there is quite a need to set forth an improvement means to solve this problem.

### SUMMARY

In view of the issue of the poor reflection amount of the window layer encountered in the prior art and thus the largely reduced isolation effect in the course of an excess of absorption of the infrared light, the present invention provides a window film structure for reflecting an infrared light, which comprises a window film layer, reflecting the infrared having a first wavelength; a cholesteric liquid crystal layer, disposed on the window film layer, reflecting the infrared having a second wavelength; and a protection layer, disposed on the cholesteric liquid crystal layer.

In an embodiment, the cholesteric liquid crystal layer comprises a nematic liquid crystal and an optical activity compound.

In an embodiment, the cholesteric liquid crystal layer determines the second wavelength range according to a weight percentage of the nematic liquid crystal.

In some embodiments, when the nematic compound has a weight percentage of 10%, the second wavelength range is 1300 nm to 1600 nm, when the nematic compound has a weight percentage of 15%, the second wavelength range is 900 nm to 1200 nm, when the nematic compound has a weight percentage of 20%, the second wavelength range is 700 nm to 850 nm, when the nematic compound has a weight percentage of 25%, the second wavelength range is 350 nm to 600 nm.

In an embodiment, the protection layer is polyethylene terephthalate (PET).

In an embodiment, the window layer further comprises the infrared light having a third wavelength range.

In an embodiment, the window layer, the cholesteric liquid crystal layer and the protection layer each have an optical transmittance.

The structure of the present invention has the difference as compared to the prior art that the window layer not only reflects the infrared light having the first wavelength range by its window film layer, but also reflects the infrared light having the second wavelength range by using its cholesteric liquid crystal layer, so that the window layer structure of the present invention may reflect the infrared light of a large portion of wavelengths and reduce an absorption of the infrared light. Therefore, the window layer for reflecting an infrared light may provide a more efficient isolation effect.

By using the above technical means, the present invention may achieve a reflection of the infrared light of a large portion of wavelengths, and thus an improved heat isolation effect.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a schematic diagram for a heat energy accumulation in a prior art window layer;

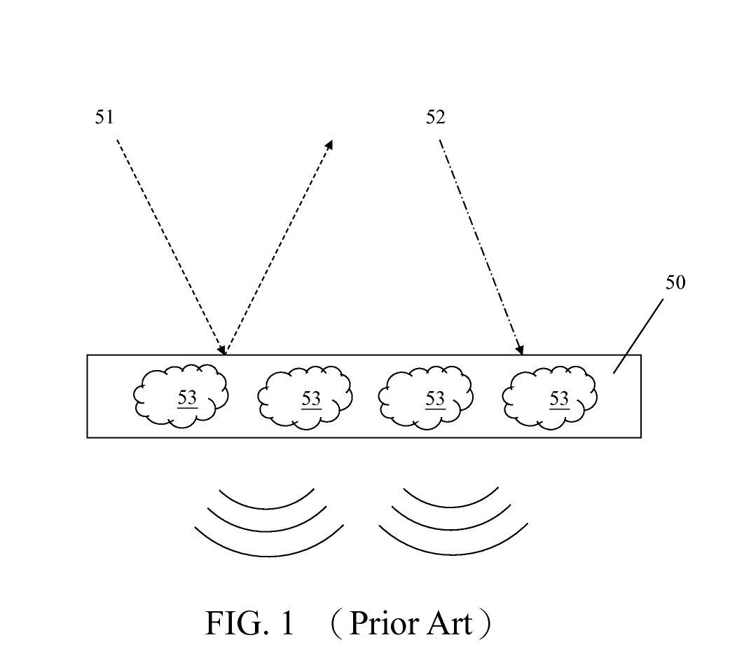

FIG. 2 is a planer diagram of a window layer for reflecting an infrared light according to the present invention;

FIG. 3 is a schematic diagram for illustrating an infrared light reflection of the window layer for reflecting an infrared light according to the present invention; and

FIG. 4 is a schematic diagram for illustrating a heat energy accumulation of the window layer for reflecting an infrared light according to the present invention.

### DETAILED DESCRIPTION

The present invention will be apparent from the following detailed description, which proceeds with reference to the accompanying drawings, wherein the same references relate to the same elements.

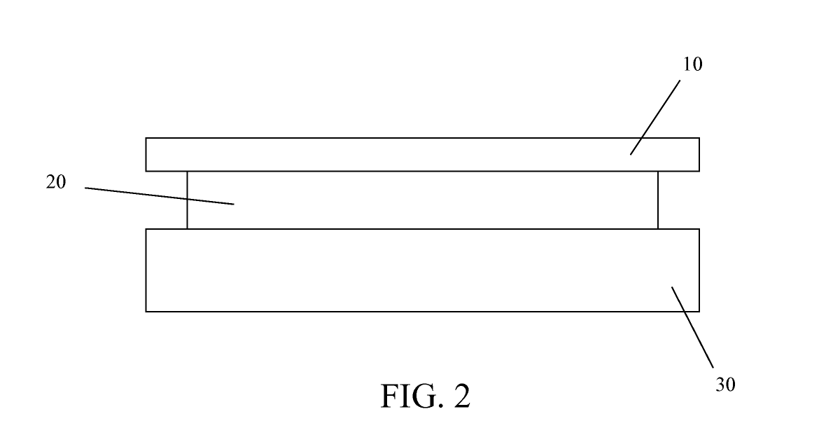

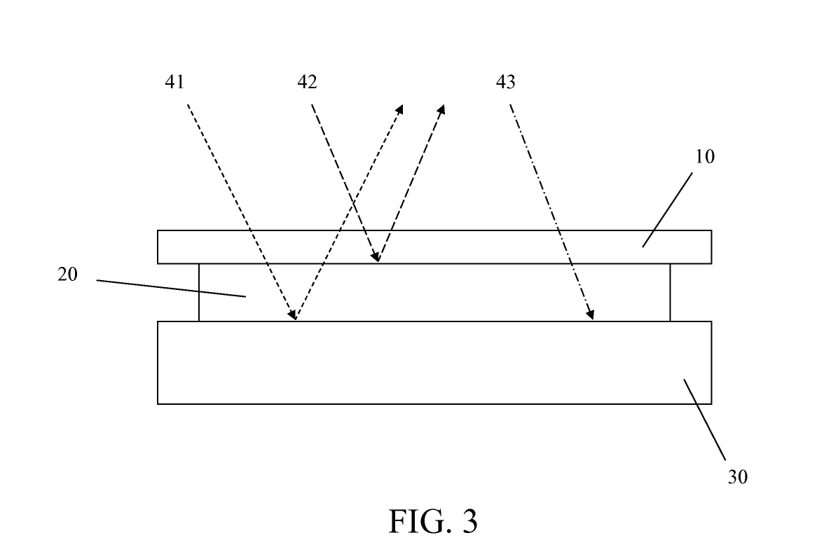

In the following, a window layer structure for reflecting an infrared light of the present invention will be described with reference simultaneously to FIG. 2 and FIG. 3, in which FIG. 2 is a planer diagram of a window layer for reflecting an infrared light according to the present invention, and FIG. 3 is a schematic diagram for illustrating an infrared light reflection of the window layer for reflecting an infrared light according to the present invention.

The window layer structure for reflecting an infrared light of the present invention comprises a protection layer 10, a cholesteric liquid crystal layer 20, and a window film layer 30.

The window film layer 30 is composed of a plurality of recycle materials, comprising a polyethylene terephthalate (PET) layer, a metal reflection an organic dye coating layer, a scrape-protecting layer, and a sticker coating layer.

The window film layer 30 reflects the infrared 41 having a first wavelength and an ultraviolet light, and absorbs the infrared light 43 having a third wavelength range by using the organic dye coating layer, so as to achieve a heat isolation effect.

However, when heat organic dye coating layer of the window layer film 30 absorbs the infrared light 43 of the third wavelength, the window film layer 30 will release the heat energy absorbed by the organic dye coating layer in a heat radiation form and results in an increased temperature. To avoid this phenomenon from occurring, a cholesteric liquid crystal layer 20 is disposed on the window film layer 30, to reflect the infrared 42 having a second wavelength.

By using the window film layer 30, the infrared light of the first wavelength range 41 may be reflected. Then, by using the cholesteric liquid crystal layer 20, the infrared light 42 of the second wavelength range may be reflected. As such, a large portion of the infrared light wavelength range may be reflected. That is, the infrared light of the third wavelength range absorbed by the organic dye coating layer of the window film layer 30 may be considerably reduced, and thus an improved heat isolation effect is provided.

The infrared light ranges of the first, second and third wavelength ranges 41, 42, and 43 are illustrated in FIG. 2 by different dash line forms, which are merely examples without limiting the present invention.

The cholesteric liquid crystal layer 20 comprises a nematic liquid crystal and optical activity compound. The cholesteric liquid crystal layer 20 has its spiral structure and thus a unique optical property, which is a generation of a selective reflection. When an incident light is used to define an optical rotation direction of a circular polarization, if the incident light has the circular polarization having the same direction maintained in the spiral direction, the incident light is selectively reflected. The wavelength of the selective reflected light may be deduced: λ=n*p, wherein λ is the wavelength of the reflected light (nm), P is a pitch (nm), n is an average refractive index on a plane vertical to the spiral.

It is to be noted that when the nematic compound has a weight percentage of 10%, the second wavelength range is 1,300 nm to 1,600 nm, when the nematic compound has a weight percentage of 15%, the second wavelength range is 900 nm to 1,200 nm, when the nematic compound has a weight percentage of 20%, the second wavelength range is 700 nm to 850 nm, and when the nematic compound has a weight percentage of 25%, the second wavelength range is 350 nm to 600 nm. However, these are merely examples without limiting the present invention.

Different window film layers 30 may be used to reflect the infrared light 41 of the first wavelength range. Further, a weight percentage of the optical activity compound in cholesteric liquid crystal layer 20 may be selected, so that the first and second wavelength ranges 41, 42 reflected by the window film layer 13 and the cholesteric liquid crystal layer 20 may include a large portion of the infrared wavelength range, so that the window film layer structure for reflecting an infrared light may further have a more effective heat isolation result.

For example, assume the window film layer 30 may reflect the infrared light 41 of the first wavelength range, 900 nm to 1,600 nm, the cholesteric liquid crystal layer 20 is selected to have a weight percentage of the optical activity compound of 20%, so that the window layer structure for reflecting an infrared light may reflect such infrared light of the wavelength ranges of 700 nm to 850 nm and 900 nm to 1,600 nm.

For example, assume the window film layer 30 may reflect the infrared light 41 of the first wavelength ranges, 700 nm to 850 nm and 1,300 nm to 1,600 nm, the cholesteric liquid crystal layer 20 may select the optical activity compound to have a weight percentage of 15%, so that the window layer for reflecting an infrared light may reflect the infrared light of the wavelength ranges of 700 nm to 850 nm, 900 nm to 1,200 nm and 1,300 nm to 1,600 nm.

Thereafter, a protection layer 10 is further disposed on the cholesteric liquid crystal layer 20, and used to protect the cholesteric liquid crystal layer 20, so as to avoid the cholesteric liquid crystal layer 20 from being damaged. On the other hand, the window layer 30, the cholesteric liquid crystal layer 20, and the protection layer 10 all have the optical transmittance of a visible light.

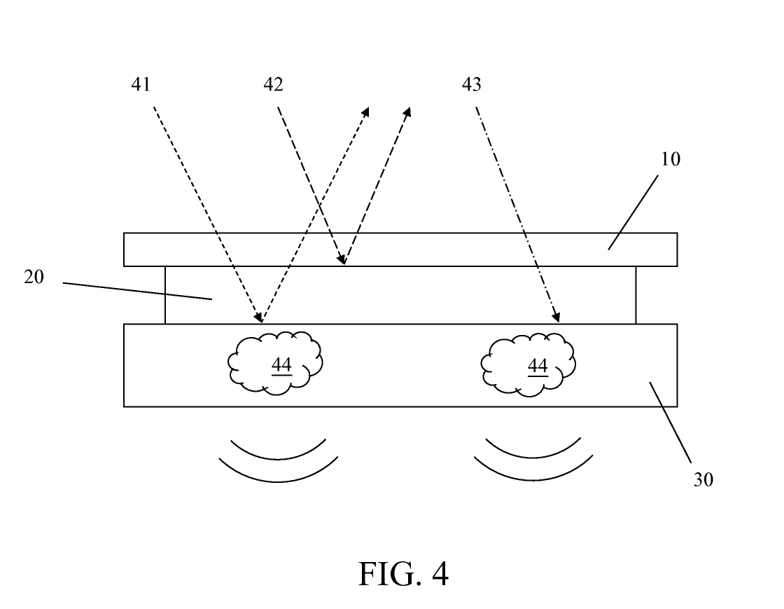

Thereafter, referring to FIG. 4, which is a schematic diagram for illustrating a heat energy accumulation of the window layer for reflecting an infrared light according to the present invention.

By using the window film layer 30 itself, the infrared light 41 of the first wavelength range may be reflected. Then, the cholesteric liquid crystal layer 20 reflects the infrared light 42 of the second wavelength range. As such, a large portion of wavelength range of the infrared light are reflected, and this may largely reduces the infrared light of the third wavelength range absorbed by the organic dye coating layer of the window film flayer 30. This further reduces an accumulation speed of the heat energy 44 in the window film layer 30.

Certainly, in the case where the infrared light 43 of the third wavelength range absorbed in the window layer 10 is reduced, the heat energy 44 accumulated in the window film layer 10 may not excess. Although the heat energy 44 accumulated in the window film layer 30 may remain released in a heat radiation manner, the temperature in the space required to be thermally isolated will not have a significant variation owing to the heat energy 44 being not large. This lends to a more effective heat isolation effect to be had by the window layer for reflecting an infrared light.

The structure of the present invention has the difference as compared to the prior art that the window layer of the present invention not only reflects the infrared light having the first wavelength range by its window film layer, but also reflects the infrared light having the second wavelength range by using its cholesteric liquid crystal layer, so that the window layer structure of the present invention may reflect the infrared light of a large portion of wavelengths and reduce an absorption of the infrared light. Therefore, the window layer for reflecting an infrared light of the present invention may provide a more efficient isolation effect.

By using this technical means, the issue of the poor reflection amount of the window layer encountered in the prior art may be solved, and thus the efficacy of largely reduced isolation effect in the course of an excess of absorption of the infrared light may be achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A window film structure for reflecting an infrared light, comprising:
a window film layer, reflecting the infrared having a first wavelength;
a cholesteric liquid crystal layer, disposed on the window film layer, reflecting the infrared having a second wavelength; and
a protection layer, disposed on the cholesteric liquid crystal layer.

2. The window film structure for reflecting the infrared light as claimed in claim 1, wherein the cholesteric liquid crystal layer comprises a nematic liquid crystal and an optical activity compound.

3. The window film structure for reflecting the infrared light as claimed in claim 2, wherein the cholesteric liquid crystal layer determines the second wavelength range according to a weight percentage of the nematic liquid crystal.

4. The window film structure for reflecting the infrared light as claimed in claim 3, wherein when the nematic compound has a weight percentage of 10%, the second wavelength range is 1300 nm to 1600 nm.

5. The window film structure for reflecting the infrared light as claimed in claim 3, wherein when the nematic compound has a weight percentage of 15%, the second wavelength range is 900 nm to 1200 nm.

6. The window film structure for reflecting the infrared light as claimed in claim 3, wherein when the nematic compound has a weight percentage of 20%, the second wavelength range is 700 nm to 850 nm.

7. The window film structure for reflecting the infrared light as claimed in claim 3, wherein when the nematic compound has a weight percentage of 25%, the second wavelength range is 350 nm to 600 nm.

8. The window film structure for reflecting the infrared light as claimed in claim 1, wherein the protection layer is polyethylene terephthalate (PET).

9. The window film structure for reflecting the infrared light as claimed in claim 1, wherein the window layer further comprises the infrared light having a third wavelength range.

10. The window film structure for reflecting the infrared light as claimed in claim 1, wherein the window layer, the cholesteric liquid crystal layer and the protection layer each have an optical transmittance.
